(19) United States
(12) Patent Application Publication
(10) Pub. No.: US 2004/0080494 A1
(43) Pub. Date: Apr. 29, 2004

(54) Force-sensing mouse pointing device for computer input

(75) Inventor: Scott E. Fahlman, Pittsburgh, PA (US)

Correspondence Address: Eric W. Petraske, 68 Old Hawleyville Road, Bethel, CT, 06801, US

(73) Assignee: INTERNATIONAL BUSINESS MACHINES CORPORATION, Armonk, NY

(21) Appl. No.: 10/283,587

(22) Filed: Oct. 29, 2002

(51) Int. Cl. G09G 5/08

(52) U.S. Cl. 345/163

(57) ABSTRACT

Force-Sensing Mouse Pointing System for Computer Input A mouse has a set of force sensors that measure vertical force with respect to the surface on which the mouse moves and pass information to the computer system in question. The mouse output can be used for: 1) downward force; 2) tilt in several directions; 3) rotation. The relevant application program can use the data for any number of purposes.

### TECHNICAL FIELD

The field of the invention is that of constructing a mouse or other mouse-like pointing device for a computer system that has the capability of sensing vertical force.

### BACKGROUND OF THE INVENTION

Most of today's desktop computers are equipped with a “mouse” pointing device, meaning a unit having a generally horizontal shape and adapted to be held in the user's hand. The mouse provides fine-grained two-dimensional input, which is normally reflected by the 2-D motion of a cursor on the computer's display screen. A typical mouse also provides one or more buttons and perhaps a scrolling wheel. A recent mouse from Apple does not have any buttons on the upper surface. Rather it uses the entire upper shell of the mouse as a single button to provide the binary input of a button.

An electronic drawing tablet provides similar capabilities for 2-D input, plus some additional capabilities. The tablet can sense the downward force or pressure with which the user presses the pen against the tablet, as well as the motion or location of the pen tip. The shape of the unit held in the hand is that of a pen—i.e. a cylinder that is adapted to be held in a generally vertical position. This additional input is used in drawing packages in many ways, for example to control the width or color of a line as the user draws it on the tablet. Many users of graphics or computer-aided design programs consider this extra input dimension to be indispensable.

A pressure-sensing pen can also subsume the function of the primary mouse button: if the pen is moved lightly across the tablet, the cursor moves, but in “button not pushed” mode; if the user presses a bit harder, the cursor moves in “button pushed” mode (sometimes referred to as “drag” mode). There may be one or two buttons on the pen or stylus, but this “virtual button” is less awkward for most purposes.

Some electronic tablet systems also sense the tilt of the pen relative to the tablet surface, both in the X and the Y direction. This provides two more continuous dimensions of input, though the angular resolution of the tilt sensing is rather coarse.

Some workers have developed a mouse with a curved bottom that can sense X Tilt and Y Tilt as well as X and Y motion. This is implemented using a tilt-sensing tablet with a pen that is encased in a mouse-shaped block with a curved bottom. This system does not have a vertical force sensor.

In drawing programs, the primary use of pen-tilt sensing is to simulate the effects of using a calligraphic brush or airbrush: the image of the simulated brush tip or spray pattern is elongated in the direction of the pen's tilt.

As 3D virtual-reality simulations become more popular, these additional input dimensions could be very useful for controlling simulated entities (manipulators or vehicles, for example) with many degrees of freedom. However, pen/tablet devices are seldom used as game controllers because they are too delicate for use in the heat of virtual combat.

Despite the additional power and flexibility that electronic tablets provide, the mouse is still the preferred input device for the vast majority of users. Compared to a typical mouse, a tablet has a number of disadvantages:

The tablet is more expensive. A 6″×8″ tablet costs considerably more than the cost of a decent-quality mouse.

The tablet is a rigid 2-D plate and is therefore less portable than a mouse.

The tablet occupies valuable prime desk space. It is easier to clear a small space to use a mouse than the larger space a tablet requires.

The tablet's wireless pen or stylus is fragile and easily lost.

Moving your hand from the keyboard to the mouse is easier and faster than picking up a pen, and can usually be done without glancing at the mouse. It is also easier to find the mouse buttons by feel than to rotate a pen into the proper position for use of its buttons.

Because they are ubiquitous, mice now feel familiar and natural to most users.

Thus, it would be desirable to have a rugged, low-cost input device with all the advantages of a mouse, but that provides the additional input dimensions of an electronic tablet.

### SUMMARY OF THE INVENTION

The invention relates a mouse-like pointing device that senses the downward force of the user's hand, and transmits that force information to the computer.

A feature of the invention is the use of at least one force sensor that provides information on the applied force.

Another feature of the invention is the location of force sensors between an upper shell and the body of the mouse.

Another feature of the invention is the ability to sense a tilt.

Another feature of the invention is the ability to point, using the tilt feature, in a direction while the mouse is stationary.

Yet another feature of the invention is the location of force sensors at the buttons of the mouse.

Yet another feature of the invention is the location of force sensors on the feet of the mouse.

### BRIEF DESCRIPTION OF THE DRAWINGS

FIG. 1A shows a bottom view of the invention.

FIG. 1B shows a cross section of the embodiment of FIG. 1A.

FIG. 2 shows a cross section of an alternative embodiment of the invention.

FIG. 3 shows a block diagram of an analysis system for use with the invention.

### DETAILED DESCRIPTION

A mouse typically slides across the table on three or four smooth plastic feet on its lower surface. In the center is a soft rubber ball or optical system that senses the mouse's X-Y motion across the table. The user's hand rests on a plastic upper shell upon which the buttons are mounted.

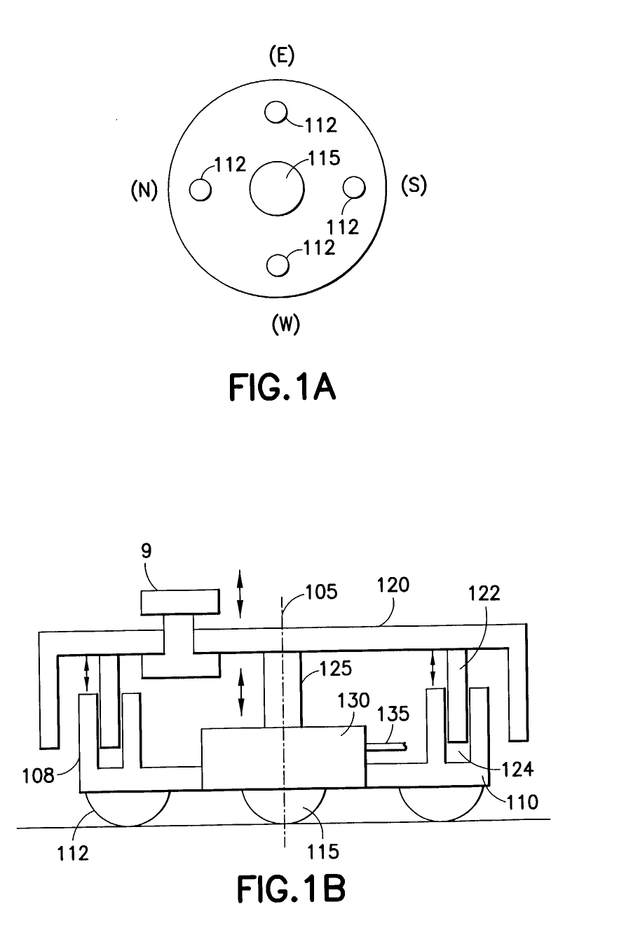

Referring to FIG. 1A, there is shown a bottom view of a mouse according to the invention, in partially pictorial, partially schematic form. The body of the mouse 110, represented by a circle, rests on four smooth plastic feet 112. At the center, circle 115 represents either a lens for a conventional optical sensor system or a ball for a conventional mechanical sensor.

FIG. 1B shows a cross section of the mouse, with upper shell 120 mounted to slide vertically with respect to lower shell 110. The sliding motion is permitted by pins 122, which move in apertures 124 in a projecting rim 108 of lower shell 110. Pins 122 or equivalent will be referred to as direction restriction means, since their function is to restrict the relative motion of the upper shell and base to motion parallel to a vertical axis 105. Two pins are shown in this cross section, but any convenient number may be used. Alternatively, flanges on the outer shell may slide within slots or guides on the body.

In the mouse, there is at least one force sensor 125 between the upper shell and the lower platform of the mouse. This is set up to sense downward force on the upper surface. In this example, a single force sensor 125, represented schematically by a rectangle positioned between the lower surface of upper shell 120 and an electronics package 130, is a conventional inexpensive sensor that produces a response to vertical force applied parallel to vertical axis 105. The vertical motion is represented by arrows next to the pins 122 and the force sensor 125.

A hemisphere 115, at the center of the lower shell, represents schematically both the mechanism for a mechanical mouse (including spring mounts or other compliance unit) and the lens and other optical detector for an optical mouse. There will be conventional sensors (and also typically electronics) located within box 130 to generate signals representing the horizontal translation of the mouse across the surface.

Box 130 represents any electronics located in the shell and line 135 represents a cable or wireless link between the mouse and the computer to which the mouse is attached. In operation, the force sensor 125 will register force applied to upper shell 120. Electronics box 130 contains at least one analog to digital (A/D) converter connected to the force sensors that digitize the force, illustratively providing a digital output signal in one of N quantized levels. For example, there may be a “dead zone” of between 0 and C1 Newtons that counts as zero force and then a number of levels at force intervals selected by the designer. Preferably, the dead-zone, range, and scaling are determined by the individual user of the system via runtime settings in the mouse driver or the application software. The value for C1 and the number of levels will be selected in a tradeoff between precision and the motor control ability of the average user. Many commercial packages can sense 512 levels of force. There may be one A/D converter per force sensor or there may be fewer A/D converters that sequentially measure the sensors. In a simple example, at least one sensor must have a signal representing more than C1 Newtons in order to send a signal to the application program (or the application program ignores a signal less than C1). Alternative analysis schemes are described below.

The compliance required by typical force sensors is small. The amount of travel when one pushes down on the upper surface of the mouse, is very small, perhaps a millimeter or less for the forces a typical user would apply.

An optical mouse is preferable to a mechanical one as the basis for the force-sensing mouse, since the optical element will not be affected by variations in downward pressure. However, a suitable mechanical ball-type mouse can easily be constructed with the ball mounted so that it maintains steady contact with the table regardless of any compression of the mouse feet. Any number of mounting systems—springs, elastomers, sponge rubber pads or many other interfaces that have a “give” that accommodates the motion required to operate the force sensor—will be suitable. Such systems that provide the mechanically compliant interface between the upper and lower parts of the shell (or other moving parts) will be referred to generally as a “compliance unit”.

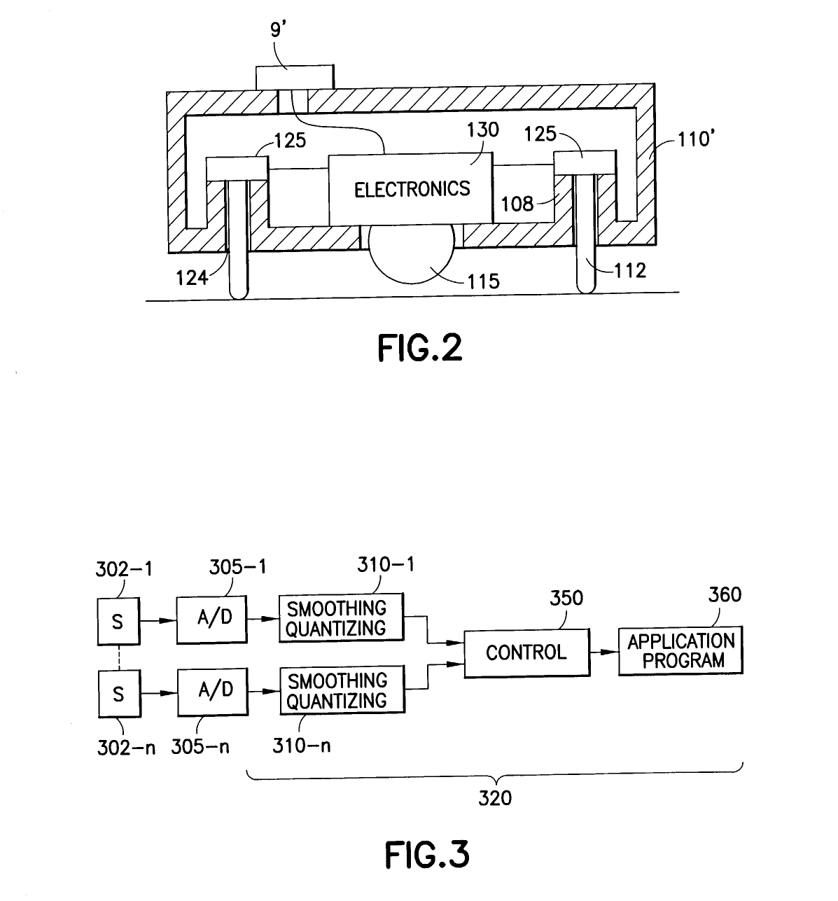

Referring to FIG. 2, there is shown a cross section of an alternative embodiment, in which two force sensors 125 are shown as mounted to detect force upward through pins 122, which slide through apertures 124 in shell 110′. These pins are the mouse's feet, or extensions attached to the feet.

Small, cheap, and rugged force sensors of the kind described here are readily available.

A designer may choose to employ a multi-wire cable to connect the force sensors to an electronics package located outside the mouse that performs analog to digital conversion and simple logic processing, or may choose to use onboard electronics. Most modem mice, even inexpensive ones, already have electronics on board, so that a qualitative change is not required.

“Tilt” Sensing

An alternative example to the use of a single sensor is the use of a mouse with three or four feet having an independent vertical force sensor on each of the feet, as shown in FIG. 2. For purposes of illustration, we will assume three feet, labeled “Front”, “Left”, and “Right”. We now can provide five continuous input dimensions:

1. X: Side to side motion of the mouse across the table.

2. Y: Back to front motion of the mouse across the table.

3. Z: Total downward pressure of the user's hand. This is the sum of the downward forces sensed on all three feet.

4. Tilt X: Difference between the downward force on the Left foot and the downward force on the Right foot.

5. Tilt Y: Difference between the force on the Front foot and the total force on the two back feet.

The application program will preferably analyze the magnitude of tilt, whether analog (X degrees) or digital (between Y and Z degrees, etc.) and take action determined by the program designer. The tilt signal will have both a magnitude and angular direction associated with it. Both of these can be quantized.

Another alternative is that shown in FIG. 1A, having four feet, referred to as N, E, S and W, using the compass points (i.e. azimuthal directions) labeled in the Figure as the references. Those skilled in the art will be aware that the mouse may have any number of feet. Yet another alternative is mounting the sensors between an upper and lower shell. It should be noted that, when motion restricting pins are used, the mechanical tilt will be quite small. The word “tilt” as used in the preceding example includes a difference in force, whether or not there is any significant angular motion.

In this case, the available signals are:

1. X: Side to side motion of the mouse across the table.

2. Y: Back to front motion of the mouse across the table.

3. Z: Total downward pressure of the user's hand. This is the sum (or average) of the downward forces sensed on all feet.

4. Tilt X: Difference between the force on the E foot and the force on the W foot.

5. Tilt Y: Difference between the force on the N foot and the force on the S foot.

The tilt X and tilt Y signals also can be used to indicate any azimuthal direction. This pointing signal can be used by the application program when the mouse is stationary. The signals 4 and 5 could be the raw force on the relevant sensor or a normalized signal derived by taking the difference between the opposite signals divided by their sum (or some similar calculation). Signals derived by calculation of various kinds, whether analog or digital, will be referred to in the claims as “derived force signals”.

The vector sum of forces is the sum of F₁Xᵢ and F₁Yᵢ, where F is always positive and X and Y may be positive or negative. Holding down one or both of the mouse buttons while pointing increases the available options that can be indicated to the application program.

A tilt signal can also be used to control scrolling without moving the mouse horizontally (i.e. the cursor moves in the direction of the tilt) or pointing and motion can be combined. For example, the user could tilt (or point) to the North, indicating a particular option on a menu (e.g. solid or dashed line) and move the mouse to the West, drawing an East-West line. In addition, the user could press with a particular force that selected another option (e.g. the amount of force selects the width of the line).

Referring to FIG. 3, there is shown a block diagram of a simple system to process data from the sensors. On the left, sensors 302-1 to 302-n sense force. A/D 305-1-305-n convert the signal from the sensor to digital form. Boxes 310-1-310-n smooth the data by averaging (e.g. over ¼ second) to eliminate fluctuations in pressure on the sensor and quantize the output from the A/D in convenient “bins”, e.g. 512. Control 350 represents a logic unit (which may be a CPU) that processes the signal under program control, for example to enable or disable pressure sensing or tilt sensing. Box 360 represents the application program that receives the pointing and pressure data. The elements indicated by bracket 320 may conveniently be located in the computer that the mouse is attached to. The A/D units may be located in the mouse, since they are not ordinarily found in a general purpose computer. Alternatively, they may be located in a box plugged into the mouse port, in order to reduce the volume of the mouse. The phrase “sensing system” will be used to describe the combination of the mechanical mouse apparatus, electronics package and calculating equipment, whether it is entirely contained within the mouse shell, whether the mouse plugs into an electronics package that is connected to the computer, or whether parts are located in the computer to which the mouse is attached.

Rotation Sensing

Sensing rotation around a vertical axis, provides an additional continuous input dimension. In an optical mouse, this can be done by using a second optical sensor on the bottom of the mouse, some distance away from the primary sensor. Rotation of the mouse shows up as a difference between the X motion seen by one sensor and the X motion seen by the other.

Force Sensors on the Buttons

It is also possible to add a force sensor to one of more of the mouse buttons 9 or 9′. It is preferable to retain some tactile “snap” to indicate whether the button is pushed or not pushed. However, once the button has been pushed, it is possible to sense how hard the user is pressing it.

A mouse constructed according to the preceding description would be rugged and inexpensive. It would provide the expressive power of an electronic tablet, but with the convenience and familiarity of a standard mouse. When not being used with drawing packages or other applications that make use of the additional input dimensions, the device could be used just like a standard mouse. A force-sensing mouse that has been made sufficiently rugged may be used as a 5-D game controller as well.

Present and future software that makes use of pressure information from a pen/tablet would, without modification, be able to use the force information from this mouse.

The principles described above also apply to trackballs, which are stationary devices performing the functions of a mouse in which the translation sensor is mounted on the top and turned with the fingers. Trackballs are included within the definition of a mouse-like device, since they have generally horizontal shape and are not held like pens.

While the invention has been described in terms of a single preferred embodiment, those skilled in the art will recognize that the invention can be practiced in various versions within the spirit and scope of the following claims.

What is claimed is:

1. A sensing system for providing input to a computer and comprising a substantially horizontal body enclosing sensing means for sensing translation in a horizontal plane, further comprising:
at least one force sensor oriented to sense vertical force perpendicular to the horizontal.

2. A sensing system according to claim 1, in which said at least one force sensor comprises a single force sensor.

3. A sensing system according to claim 1, further comprising a set of at least two vertical force sensors.

4. A sensing system according to claim 3, further comprising electronic means responsive to said set of at least two vertical force sensors for sensing the difference between two sensors disposed on opposite sides of a horizontal axis, thereby sensing the magnitude of a tilt along said horizontal axis.

5. A sensing system according to claim 3, further comprising electronic means responsive to said set of at least two vertical force sensors for sensing all of the outputs of said sensors, thereby sensing a force applied to said sensors.

6. A sensing system according to claim 3, further comprising electronic means responsive to said set of at least two vertical force sensors for sensing all of the outputs of said sensors sequentially.

7. A sensing system according to claim 3, further comprising electronic means responsive to said set of at least two vertical force sensors for sensing all of the outputs of said sensors; and
further comprising signal forming means for forming a derived signal from said set of sensors.

8. A sensing system according to claim 7, comprising a set of at least three sensors disposed about a vertical axis, whereby said signal forming means indicates a horizontal direction.

9. A sensing system according to claim 7, in which said derived signals represents a vector sum of said outputs of said sensors.

10. A sensing system according to claim 7, in which said set of sensors and said signal forming means are adapted to indicate an above-threshold azimuthal signal.

11. A sensing system according to claim 2, further comprising means for indicating the magnitude of said vertical force, said magnitude being divided into at least two steps.

12. A sensing system according to claim 3, further comprising means for indicating the magnitude of the vertical force sensed by each of said sensors, said magnitude being divided into at least two steps.

13. A sensing system according to claim 12, further comprising forming means for forming a derived signal representative of the degree of tilt from said set of sensors.

14. A sensing system according to claim 4, further comprising means for indicating the magnitude of the vertical force sensed by each of said sensors, said magnitudes being divided into at least two steps, whereby the difference between the magnitude of the vertical force sensed by each of said sensors indicates the magnitude of said tilt.

15. A sensing system according to claim 1, further comprising first and second sensors for sensing horizontal motion and electronic means for indicating a rotation in the horizontal of said sensing system.

16. A sensing system according to claim 1 and having an upper shell and a base, further comprising direction restricting means for restricting relative motion of said upper shell and said base to be substantially parallel to a vertical axis.

18. A sensing system according to claim 16, comprising a set of at least four sensors disposed about an azimuth, whereby said means for indicating indicates a horizontal direction.

19. A sensing system according to claim 18, in which said set of sensors are disposed to indicate at least eight symmetric azimuthal directions.

20. A sensing system according to claim 19, further comprising first and second sensors for sensing horizontal motion and electronic means for indicating a rotation in the horizontal of said base.

21. An article of manufacture in computer readable form comprising means for performing a method for operating a computer system comprising a sensing system for providing input to said computer and comprising a substantially horizontal body enclosing sensing means for sensing translation in a horizontal plane, at least two force sensors oriented to sense vertical force perpendicular to the horizontal, electronic means responsive to said set of at least two vertical force sensors for sensing the difference between two sensors disposed on opposite sides of a horizontal axis, thereby sensing the magnitude of a tilt along said horizontal axis, said method comprising the steps of:
sensing outputs of said at least two force sensors;
converting said outputs of said at least two force sensors to digital form; smoothing said outputs over a time period to generate smoothed outputs of said at least two force sensors to reduce fluctuations therein; and
passing said smoothed outputs to application program means.
